(19) United States
(12) Patent Application Publication
(10) Pub. No.: US 2007/0290053 A1
(43) Pub. Date: Dec. 20, 2007

(54) PRE-PROCESSING CLEANING OF PRE-PRINTED DOCUMENTS

(75) Inventors: Raphael F. Bov, Pittsford, NY (US); Santokh S. Badesha, Pittsford, NY (US); Peter S. Fisher, Pasadena, CA (US); T. Brian McAneney, Burlington (CA); Kurt I. Halfyard, Mississauga (CA); Alexander Vakov, Etobicoke (CA)

Correspondence Address: FREDERICK W. GIBB, III;Gibb & Rahman, LLC, 2568-A RIVA ROAD, SUITE 304, ANNAPOLIS, MD, 21401, US

(73) Assignee: Xerox Corporation

(21) Appl. No.: 11/424,243

(22) Filed: Jun. 15, 2006

(51) Int. Cl. G06K 19/06; G06F 15/12

(52) U.S. Cl. 235/493; 235/432

(57) ABSTRACT

A method cleans at least a region of a document to remove amino-functional group release agents from the region cleaned. Then, processed data can be recorded in the cleaned region using a MICR encoder without encountering problems with the amino-functional group release agents.

### BACKGROUND

Embodiments herein generally relate to processing pre-printed documents and more particularly to a process that cleans at least a portion of the pre-printed documents before processing them.

As explained in U.S. Patent Publication 2005/0285918 (the complete disclosure of which is incorporated herein by reference) inks suited for use in printing magnetic ink character recognition (MICR)-readable documents are known. Such inks are generally employed in the printing and preparation of documents intended for automated processing, such as checks.

Of particular interest in this instance are those inks which contain a magnetic pigment or component in an amount sufficient to generate a magnetic signal strong enough to be MICR-readable. Such inks generally fall into the category of magnetic inks in general, and in the more specific sub-category of MICR-readable inks. Generally the ink is used to print a portion of a document, such as checks, bonds, security cards, etc. containing an identification code area, usually at the bottom of the check, which is intended for automated processing. The characters of this identification code are usually MICR encoded. The document may be printed with a combination of MICR-readable ink and conventional ink, or with just MICR-readable ink. The document thus printed is then exposed to an appropriate source or field of magnetization, at which time the magnetic particles become aligned as they accept and retain a magnetic signal. The identification code on the document can then be recognized by passing it through a reader device which detects the magnetic signal of the MICR imprinted characters, or “reads” the signal, in order to recognize the coding printed on the document. Of particular importance in the foregoing is the ability of the magnetic component of the ink to retain a sufficient charge such that the printed characters retain their readable characteristic and are easily detected by the detection device or reader. The magnetic charge retained by the pigment or magnetic component is known as “remanence”.

In some situations, thermal ribbon printing mechanisms are used to generate MICR-readable characters or indicia. In this printing technique, the magnetic component is retained on a ribbon substrate by a binder and/or wax material. Then, upon application of heat and pressure, the magnetic ink is transferred to a substrate. Other details regarding thermal ribbon printing technology are discussed in detail in U.S. Patent Publication 2004/0137203, which is also incorporated herein by reference.

### SUMMARY

Embodiments herein include a method to enable the encoding of data on pre-printed forms. The surface of many pre-printed documents contains polydimethylsiloxanes having functional groups e.g., amino, mercapto, hydroxyl, hydride, and halogens. These functional and non functional silicone release agents (oils) are used when the pre-printed form is made (when the pre-printed form is originally printed). It has been observed that all release oils interfere with the subsequest document processing steps. However, in the situations when amino oil is used as a release oil to make the preprinted form, the amino-functional group interferes the most with the subsequent document processing, such as encoding magnetic ink character recognition (MICR) data on the pre-printed document.

The encoding method reads data that was previously recorded in the pre-printed document. For example, the method can read data that was hand written or machine printed in a blank in the pre-printed form. Thus, the method can read monetary amounts written or printed in blanks of pre-printed checks. The method processes the recorded data from the field of the pre-printed form. This processing can include, for example, optical character recognition.

The embodiment herein provides a means to clean a region of the document to remove the amino-functional group release agents from the region cleaned. Then, the encoding method can record the processed data in the cleaned region using a magnetic thermal transfer ribbon (MTTR) MICR encoder without encountering problems with the amino-functional group release agents.

Thus, in one example, the cleaning method can be applied to a surface of the negotiable instrument that comprises amino-functional group release agents after the initial printing process that generates the preprinted document is completed. The method cleans a region of the document to remove the amino-functional group release agents from the cleaned region and allow recording of the proof-of-deposit data in the region using a magnetic thermal transfer ribbon magnetic ink character recognition encoder

The cleaning uses a cleaning agent that can comprise alcohol, butoxyethanol, 1-tert-butoxypropanol, propylene glycol ethers, propylene glycol co-polymers, ethylene oxide condensates Merpol® (available from Stepan Company, Northfield, Ill., U.S.A.) kerosene, hexanes, heptanes, isobutylmethyl ketone, methylethyl ketone, and/or hydrogen peroxide, citric acid, acetic acid, linear siloxanes (hexamethyldisiloxane, octamethyltrisiloxane, etc.) and cyclic siloxanes (octamethyltetracyclosiloxane, decamethylpentacyclosiloxane, etc.), aminofucntional oligosiloxanes, poly(oxy-1,2-ethaediyl),alpha-(undecyl)-omega-hydroxy, to the region of the document along with water, a surfactant such as sodium dodecylsulfate, dioctylsulfosuccinate, benzensulfonic acid, a polydimethylsiloxane (PDMS) based surfactant or fluorosurfactant. The amino-functional group release agents comprise at least one of: polydimethylsiloxane (PDMS), α-APS functional PDMS, and other functional fusing agents, as described, for example, in U.S. Pat. No. 6,743,561, the complete disclosure of which is incorporated herein by reference. The actual cleaning process itself comprises, in one embodiment, physically contacting or rubbing a contact pad containing the cleaning agent against at least the region of the document to be cleaned.

Another embodiment herein comprises printing at least one pre-printed document, wherein a surface of the pre-printed document again comprises the amino-functional group release agents. This embodiment also cleans a region of the document to remove the amino-functional group release agents from the cleaned region, as discussed previously. However, this embodiment processes the document in a finishing process, such as a binding and/or a lamination process.

These and other features are described in, or are apparent from, the following detailed description.

### BRIEF DESCRIPTION OF THE DRAWINGS

Various exemplary embodiments of the systems and methods are described in detail below, with reference to the attached drawing figures, in which:

FIG. 1 is a flow diagram illustrating one method embodiment;

FIG. 2 is a schematic diagram of a system used with embodiments herein;

FIG. 3 is a schematic diagram of a cleaner used with embodiments herein;

FIG. 4 is a schematic diagram of a cleaner used with embodiments herein; and

FIG. 5 is a schematic diagram of a cleaning system used with embodiments herein.

### DETAILED DESCRIPTION

As eluded to above, on negotiable pre-printed documents, such as checks, the MICR amount field will be encoded as part of the bank's “proof of deposit” operation. One popular device for encoding MICR amounts uses the thermal ribbon print technology discussed above. Thermal ribbon readability in MICR reader/sorters can be degraded by prior application of some fuser release agents used when originally printing the check or pre-printed document. While mercapto-functional release agents have minimal impact on recognition rates, those containing amino-functional groups severely degrade the image quality of this amount encoding technology. Embodiments herein present a methodology for eliminating the negative impact of amino-functional release agents on magnetic thermal transfer ribbon (MTTR) MICR encoders, allowing development of MICR products on platforms that use this family of release agents.

More specifically, when developing the embodiments herein, it was discovered that specific compounds found in common cleaners are capable of altering the surface characteristics of the amino-functional group contained on pre-printed documents to greatly reduce print quality degradation in thermal transfer ribbon and other MICR images. While magnetic thermal transfer ribbon printing is mentioned as an example, one ordinarily skilled in the art would understand (in light of this disclosure) that the embodiments herein are applicable to all forms of MICR encoding, especially those forms of MICR encoding that are degraded by the amino-functional release agents, including but not limited to conventional high-transfer impact MICR ribbon, laser or ion-deposition methods as discussed in U.S. Pat. No. 6,928,183, the complete disclosure of which is now incorporated herein by reference.

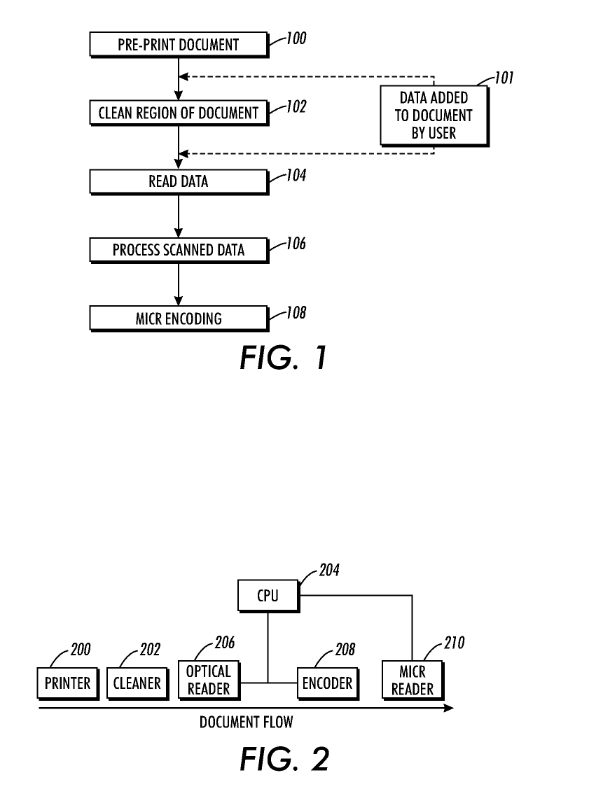

Referring now to FIG. 1, one method of encoding data on pre-printed forms is presented. Again, the surface of many pre-printed documents contain amino-functional group release agents (oils) that are used when the pre-printed form is made (when the pre-printed form is originally printed). In some situations, the amino-functional group release agents can interfere with subsequent document processing, such as encoding magnetic ink character recognition (MICR) data on the pre-printed document.

As shown in item 100 in FIG. 1, the method pre-prints the document (performs a printing process to produce a pre-printed document) to be processed, and, as shown in item 102, cleans at least the area of the document to be subsequently encoded. In item 104, a device reads (e.g., scans) data that was previously recorded in the pre-printed document and processes the scanned data (item 106) in, for example, an optical character recognition (OCR) process (see U.S. Pat. No. 6,782,144, the complete disclosure of which is incorporated herein by reference, for a description of OCR and scanning systems). This cleaning process can occur at any point prior to the MICR encoding, including before or after the data is read in item 104. For example, the method can read data that was hand written or machine printed by the user in a blank in the pre-printed form in item 101. For example, the method can read monetary amounts hand written or printed in blanks of pre-printed checks.

Then, the method can record the processed data in the cleaned region using a MICR encoder in item 110 without encountering problems with the amino-functional group release agents.

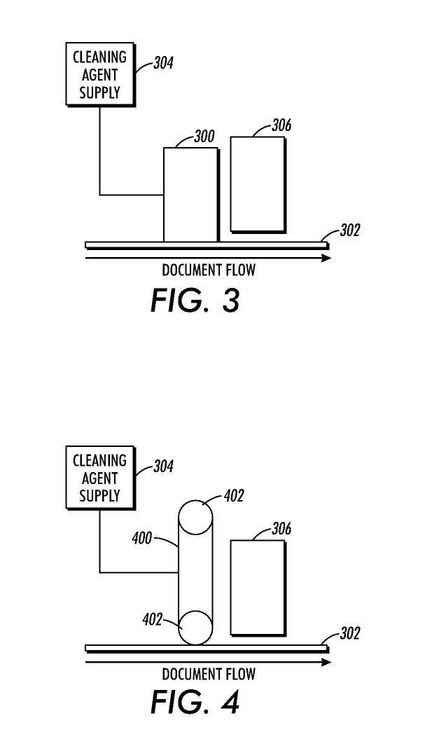

One exemplary apparatus for printing, cleaning, scanning, and encoding is shown in FIG. 2. More specifically, FIG. 2 illustrates a printer 200, a cleaner 202, a reader 206, a central processing unit (CPU) 204, an encoder 208, and a second (MICR) reader 210. The cleaner 202 is shown in greater detail in FIGS. 3 and 4, discussed below. The readers 206, 210, CPU 204, and encoder 206 are standard commercially available items, such as those discussed in the previously referenced US patents and publications, and are well-known to those ordinarily skilled in the art. Therefore, a detailed discussion of the same is omitted herefrom.

A pre-printed document moves as shown by the document flow arrow into FIG. 2, and after pre-printing by the printer 200 the document is cleaned by the cleaner 202 and read by the reader 206. The data is added to the document at any time after it is preprinted, but before it is encoded by the encoder 208. As mentioned above, the cleaner 202 can be positioned before after the reader 206 and can be completely separate from the printer 200 or the reader 206. The central processing unit 204 performs the necessary processing, such as OCR, and instructs the encoder 206 to encode the MICR data on the document, as the document passes by the encoder 208. An optional second reader 210 can be used to verify the encoding process.

FIG. 3 shows one embodiment of the cleaner, although those ordinarily skilled in the art would understand that many different forms of cleaning apparatus can be utilized within the embodiments herein. The example shown in FIG. 3 utilizes a cleaning pad 300 that physically contacts the preprinted document 302 and can, in some embodiments, be biased against the preprinted document 302. Once again, FIG. 3 illustrates the direction of document flow. The cleaning pad 300 can be stationary and perform cleaning by frictional movement of the pre-printed document 302 past the cleaning pad 300. Alternatively, the cleaning pad 300 can move in a vibrational, or rotational manner while the pre-printed document 302 remains stationary or moves past the cleaning pad 300. Another alternative embodiment is shown in FIG. 4 and includes a cleaning belt 400 that rotates around pulleys 402 to provide abrasive cleaning of the surface of the pre-printed document. As with the cleaning pad 300, the cleaning belt 400 can be used while the pre-printed document 302 is stationary or while the pre-printed document 302 moves past the cleaning belt 400.

As discussed previously, the cleaning pad 300 and cleaning belt are supplied with the aforementioned cleaning agents, for example by cleaning agent supply 304, and are used to physically and abrasively apply the cleaning agents to either the entire pre-printed document 302 or to selected locations of the pre-printed document 302 as controlled by the size of the cleaning pad 300/cleaning belt 400 and its position relative to the pre-printed document 302. In addition, the cleaner 202 can include a dryer 306 that can comprise a simple air moving device (e.g., fan, etc.) optionally combined with a heat producing device (resistive heating coils, lamp, etc.) to aid the drying of the cleaning agent if any were to remain on the pre-printed document 302 after the document passes by the cleaning pad 300/cleaning belt 400. Once again, the cleaning devices shown in FIGS. 3 and 4 are only examples, and the embodiments herein include any and all cleaning devices, whether now known or developed in the future.

Thus, in one example, the method can read a hand written or machine printed amount that was previously written or printed on a pre-printed negotiable instrument, where a surface of the negotiable instrument comprises amino-functional group release agents. The method cleans a region of the document to remove the amino-functional group release agents from the cleaned region. The method processes the amount from the field into proof of deposit data, and records the proof of deposit data in the region using a magnetic thermal transfer ribbon magnetic ink character recognition encoder.

In some embodiments only a portion of one side of the pre-printed document is cleaned; however, in other embodiments one or both sides of the pre-printed document can be cleaned. For example, both sides of the entire pre-printed document could be cleaned by having a cleaning pad 300/cleaning belt 400 on each side of the pre-printed document 302.

The cleaning uses a cleaning agent that can comprise alcohol, butoxyethanol, 1-tert-butoxypropanol, propylene glycol ethers, propylene glycol co-polymers, ethylene oxide condensates (Merpol®), kerosene, hexanes, heptanes, isobutylmethyl ketone, methylethyl ketone, and/or hydrogen peroxide, citric acid, acetic acid, linear siloxanes (hexamethyldisiloxane, octamethyltrisiloxane, etc.) and cyclic siloxanes (octamethyltetracyclosiloxane, decamethylpentacyclosiloxane, etc.), aminofucntional oligosiloxanes, poly(oxy-1,2-ethaediyl),alpha-(undecyl)-omega-hydroxy, to the region of the document along with water, a surfactant such sodium dodecylsulfate, dioctylsulfosuccinate, benzensulfonic acid, a polydimethylsiloxane (PDMS) based surfactant or fluorosurfactant. The amino-functional group release agents comprise at least one of: polydimethylsiloxane (PDMS), α-APS functional PDMS, and other functional fusing agents, as described, for example, in U.S. Pat. No. 6,743,561, the complete disclosure of which is incorporated herein by reference.

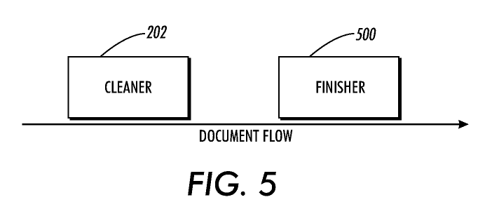

Another embodiment herein comprises receiving at least one pre-printed document, wherein a surface of the pre-printed document again comprises the amino-functional group release agents. This embodiment also cleans a region of the document to remove the amino-functional group release agents from the cleaned region, as discussed previously. However, this embodiment processes the document in a finishing process, such as a binding and/or a lamination process. Thus, as shown in FIG. 5, the cleaner 202 is utilized to clean the pre-printed document before the document reaches the finisher device 500.

Thus, as shown above, the embodiments herein include a process for altering the surface of pre-printed sheets to neutralize the negative impact of amino-functional release agents on MICR encoders. In its simplest form, a solution of commercially available cleaner is used to clean the sheet in the area of interest using a contact device and light mechanical pressure. Once the sheet dries, it is then able to receive MTTR ink with high transfer efficiency and uniformity, translating to good MICR readability.

The embodiments herein can be used with any apparatus, such as a digital copier, bookmaking machine, facsimile machine, multi-function machine, etc. which performs a print outputting function for any purpose. The details of printers, printing engines, etc. are well-known by those ordinarily skilled in the art and are discussed in, for example, U.S. Pat. No. 6,032,004, the complete disclosure of which is fully incorporated herein by reference. The embodiments herein can encompass embodiments that print in color, monochrome, or handle color or monochrome image data. All foregoing embodiments are specifically applicable to electrostatographic and/or xerographic machines and/or processes.

It will be appreciated that the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims. The claims can encompass embodiments in hardware, software, and/or a combination thereof. Unless specifically defined in a specific claim itself, steps or components of the invention should not be implied or imported from any above example as limitations to any particular order, number, position, size, shape, angle, color, or material.

What is claimed is:

1. A method comprising:
performing a printing process to produce a pre-printed document, wherein a surface of said pre-printed document comprises amino-functional group release agents;
cleaning a region of said document to remove said amino-functional group release agents from said region; and
processing said pre-printed document in a magnetic ink character encoding process.

2. The method in claim 1, wherein said cleaning comprises applying a cleaning agent comprising at least one of: alcohol, butoxyethanol, 1-tert-butoxypropanol, propylene glycol ethers, propylene glycol co-polymers, ethylene oxide condensates, kerosene, hexanes, heptanes, isobutylmethyl ketone, methylethyl ketone, hydrogen peroxide, citric acid, acetic acid, linear siloxanes (hexamethyldisiloxane, octamethyltrisiloxane) and cyclic siloxanes (octamethyltetracyclosiloxane, decamethylpentacyclosiloxane), aminofucntional oligosiloxanes, poly(oxy-1,2-ethaediyl),alpha-(undecyl)-omega-hydroxy, to said region of said document.

3. The method in claim 2, wherein said cleaning agent further comprises at least one of: water, a surfactant such as sodium dodecylsulfate, dioctylsulfosuccinate, and benzensulfonic acid, a polydimethylsiloxane (PDMS) based surfactant or fluorosurfactant.

4. The method in claim 1, wherein said cleaning comprises physically rubbing a contact pad comprising a cleaning agent against said region of said document.

5. The method in claim 1, wherein said amino-functional group release agents comprise at least one of: polydimethylsiloxane (PDMS) and α-APS functional PDMS.

6. A method comprising:
performing a printing process to produce a pre-printed document, wherein a surface of said pre-printed document comprises amino-functional group release agents;
cleaning a region of said document to remove said amino-functional group release agents from said region; and
processing said pre-printed document in one of a binding and a lamination process.

7. The method in claim 6, wherein said cleaning comprises applying a cleaning agent comprising at least one of: alcohol, butoxyethanol, 1-tert-butoxypropanol, propylene glycol ethers, propylene glycol co-polymers, ethylene oxide condensates, kerosene, hexanes, heptanes, isobutylmethyl ketone, methylethyl ketone, hydrogen peroxide, citric acid, acetic acid, linear siloxanes (hexamethyldisiloxane, octamethyltrisiloxane) and cyclic siloxanes (octamethyltetracyclosiloxane, decamethylpentacyclosiloxane), aminofucntional oligosiloxanes, poly(oxy-1,2-ethaediyl),alpha-(undecyl)-omega-hydroxy, to said region of said document.

8. The method in claim 7, wherein said cleaning agent further comprises at least one of: water, a surfactant such as sodium dodecylsulfate, dioctylsulfosuccinate, and benzensulfonic acid, a polydimethylsiloxane (PDMS) based surfactant or fluorosurfactant.

9. The method in claim 6, wherein said cleaning comprises physically rubbing a contact pad comprising a cleaning agent against said region of said document.

10. The method in claim 6, wherein said amino-functional group release agents comprise at least one of: polydimethylsiloxane (PDMS) and α-APS functional PDMS.

11. A method comprising:
reading a hand written or machine printed amount that was previously written or printed on a pre-printed document, wherein a surface of said pre-printed document comprises amino-functional group release agents;
processing said amount from said field into processed data;
cleaning a region of said document to remove said amino-functional group release agents from said region; and
recording said processed data in said region using a magnetic thermal transfer ribbon magnetic ink character recognition encoder.

12. The method in claim 11, wherein said cleaning comprises applying a cleaning agent comprising at least one of: alcohol, butoxyethanol, 1-tert-butoxypropanol, propylene glycol ethers, propylene glycol co-polymers, ethylene oxide condensates, kerosene, hexanes, heptanes, isobutylmethyl ketone, methylethyl ketone, hydrogen peroxide, citric acid, acetic acid, linear siloxanes (hexamethyldisiloxane, octamethyltrisiloxane) and cyclic siloxanes (octamethyltetracyclosiloxane, decamethylpentacyclosiloxane), aminofucntional oligosiloxanes, poly(oxy-1,2-ethaediyl),alpha-(undecyl)-omega-hydroxy, to said region of said document.

13. The method in claim 12, wherein said cleaning agent further comprises at least one of: water, a surfactant such as sodium dodecylsulfate, dioctylsulfosuccinate, and benzensulfonic acid, a polydimethylsiloxane (PDMS) based surfactant or fluorosurfactant.

14. The method in claim 11, wherein said cleaning comprises physically rubbing a contact pad comprising a cleaning agent against said region of said document.

15. The method in claim 11, wherein said amino-functional group release agents comprise at least one of: polydimethylsiloxane (PDMS) and α-APS functional PDMS.

16. A method comprising:
cleaning a region of a preprinted negotiable instrument to remove amino-functional group release agents from said region;
reading a hand written or machine printed amount that was previously written or printed on said pre-printed negotiable instrument;
processing said amount from said field into proof of deposit data; and
recording said proof of deposit data in said region using a magnetic thermal transfer ribbon magnetic ink character recognition encoder.

17. The method in claim 16, wherein said cleaning comprises applying a cleaning agent comprising at least one of: alcohol, butoxyethanol, 1-tert-butoxypropanol, propylene glycol ethers, propylene glycol co-polymers, ethylene oxide condensates (kerosene, hexanes, heptanes, isobutylmethyl ketone, methylethyl ketone, hydrogen peroxide, citric acid, acetic acid, linear siloxanes (hexamethyldisiloxane, octamethyltrisiloxane) and cyclic siloxanes (octamethyltetracyclosiloxane, decamethylpentacyclosiloxane), aminofucntional oligosiloxanes, poly(oxy-1,2-ethaediyl),alpha-(undecyl)-omega-hydroxy, to said region of said document.

18. The method in claim 17, wherein said cleaning agent further comprises at least one of: water, a surfactant such as sodium dodecylsulfate, dioctylsulfosuccinate, and benzensulfonic acid, a polydimethylsiloxane (PDMS) based surfactant or fluorosurfactant.

19. The method in claim 16, wherein said cleaning comprises physically rubbing a contact pad comprising a cleaning agent against said region of said document.

20. The method in claim 16, wherein said amino-functional group release agents comprise at least one of: polydimethylsiloxane (PDMS), and α-APS functional PDMS.
